(19) United States
(12) Patent Application Publication
(10) Pub. No.: US 2009/0031937 A1
(43) Pub. Date: Feb. 5, 2009

(54) Intake

(76) Inventors: Wylie Davin Nagler, Osprey, FL (US); Erle Matthew Bridgewater, St. Johns, FL (US); Jason Sarnowski, St. Augustine, FL (US)

Correspondence Address: SEYFARTH SHAW LLP, 131 S. DEARBORN ST., SUITE 2400, CHICAGO, IL, 60603-5803, US

(21) Appl. No.: 11/888,119

(22) Filed: Jul. 31, 2007

(51) Int. Cl. B63B 19/08; F01P 3/20; B63H 20/28; F02B 61/04

(52) U.S. Cl. 114/173; 440/88 M

(57) ABSTRACT

A water intake device is disclosed for mounting on a boat hull so that at least a peripheral portion water-side face thereof is substantially flush with an exterior surface of the boat hull. The water intake device includes a plate or screen having the water-side face and having a plurality of througbores for water uptake. The throughbores are obliquely angled with respect to the water-side face to promote water intake, and preferably are angled at approximately 20 degrees.

### CROSS-REFERENCE TO RELATED APPLICATION

The present application is related to co-pending U.S. Design patent application Ser. No. ______, titled “Intake,” and filed ______.

### FIELD OF THE INVENTION

The invention relates to water intakes for water craft and boats.

### BACKGROUND

Many water crafts and boats utilize engine coolant systems that require a continuous supply of water during operation, as well as other raw water intakes such as for live wells and raw water wash downs. Being a water craft, the necessary water source is immediately available from the water body in which the craft itself is located. During operation of the boat, an intake located with an opening or intake portion below the water line of the boat allows water to be forced or drawn therethrough and into the coolant system, live well, or other raw water system.

U.S. Pat. No. 1,641,670, to French, describes an intake for an engine coolant system. The intake includes a plate mounted to the exterior surface of the boat hull, the plate having longitudinal slots that, when mounted, are aligned with the keel of the boat. In a secondary form, a scoop may be added rearward of the slots to promote forcing water into the coolant system.

The '670 patent has a number of issues. As the plate is mounted on the exterior of the hull, it creates drag which, considering currently available performance boats, can be significant. This drag is only exacerbated by adding the optional scoop. Moreover, due to the shape of the slots, the plate is an insufficient barrier to prevent ingress of weeds and other debris, demonstrated by the presence of a strainer located downstream (inside the boat itself and intermediate the plate and the coolant system) from the plate.

It is known that intakes similar to that of the '670 patent are employed on today's power boats. The drag created by the externally affixed plate and the scoop result in cavitation of the water. Cavitated water entering the water coolant system can cause problems for the operation of the same. For example, cavitated water passing under the boat causes slippage of the prop, screws, or propeller passing therethrough; that is, the cavitated water having bubbles therein has a much lower resistance to the spinning prop, allowing the prop to jump forward which can damage the drive system, and the decrease in force being applied against the water results in a loss of forward impetus. Additionally, the plate slots are insufficient to prevent weeds and the like from passing through the plate and into the coolant system.

An example of a typical modern intake is shown in U.S. Pat. No. 4,809,632, to Hamel. Essentially, the '623 patent discloses an intake utilizing a scoop that admits weeds and other debris into the coolant system, produces drag, and results in water cavitation.

U.S. Pat. No. 1,278,882, to Donnell, discloses a sea cock having a plate secured with the exterior surface of a boat hull. The plate includes frusto-conical bores for permitting the entrance of water through the plate, the minor diameter of the bores being proximate the exterior surface of the plate. The intent of the '882 patent is to provide an intake apparatus that reduces problems associated with “obstructions and accumulations,” presumably weeds, mud, attached sea creatures, and the like. Towards this end, the bores are positioned radially from the center of the plate, and a cutting device is mounted so as to rotate about the center of the plate so that rotation thereof scrapes off the obstructions. However, the shape of the bores would, at high speed, cause eddies and turbulence therein, as would the passage leading from the bores which is generally orthogonal to the surface of the hull.

Each of U.S. Pat. Nos. 5,890,939 and 6,089,933, to Cotton, disclose intake devices having a straight pipe portion extending inwardly and orthogonally from the exterior surface of the boat hull, and having a flange mounted on exterior hull surface and projecting into the water. Grooves are cut partially into the external flange to reduce drag on the water entering the intake. However, the shape and angle of the pipe and the projection of the flange cause pressure loss, and drag which results in cavitation at high speed. Furthermore, there is no feature provided for restricting ingress of weeds and the like.

Deficiencies exist in each of the above discussed designs. In short, all currently known designs for water intakes permit ingress of undesirable matter such as weeds, have a portion projecting from the surface or skin of the hull resulting in drag and/or cavitation (both in the water in the coolant or other system and in the water through which the prop passes), or cause undesirable eddies and turbulence at the opening of the intake which reduces flow therethrough.

Accordingly, there has been a need for an improved water intake apparatus.

### SUMMARY

In accordance with an aspect, an intake device for a boat is disclosed including a body portion securable with a hull of the boat, an intake plate having a water-side surface and an interior-side surface and having a plurality of throughbores extending between the water-side and interior-side surfaces, the throughbores permitting passage of water therethrough and being obliquely angled with respect to the water-side surface of the plate.

The throughbores may be obliquely angled between 10 and 30 degrees from the water-side surface of the plate, and may be obliquely angled at approximately 20 degrees from the water-side surface of the plate.

The intake device may include an abutment portion defining the amount of receipt of the intake within the hull, wherein the water-side surface of the plate is mounted substantially flush with an exterior surface of the hull. The intake device may include a mounting portion for mounting the intake within hulls of varying thicknesses. The mounting portion may include a threadably adjustable nut having a face opposed to the abutment portion. The abutment portion may be formed on the body.

The body may include an interior passage in fluid communication with the plate throughbores for communicating water received therein to an engine coolant system, the interior passage being contoured to funnel the water to the engine coolant system.

In another aspect, in combination with a boat hull having a thickness, an interior surface, and an exterior surface, a water intake device for delivering water to an engine coolant system of the boat is disclosed including a body portion securable with the hull of the boat, an intake plate having a water-side surface and an interior-side surface and having a plurality of throughbores extending between the water-side and interior-side surfaces, permitting passage of water therethrough, and being obliquely angled with respect to the water-side surface of the plate. The water-side surface of the plate may be secured substantially flush with the exterior surface of the boat hull. The throughbores may be obliquely angled between 10 and 30 degrees from the water-side surface of the plate, and may be obliquely angled at approximately 20 degrees from the water-side surface of the plate. The intake device may further include an abutment portion defining the amount of receipt of the intake within the hull. The intake device may further include a mounting portion for mounting the intake within hulls of varying thicknesses. The mounting portion may include a threadably adjusted nut having a face opposed to the abutment portion. The abutment portion may be formed on the body.

In accordance with a further aspect, a method of providing a boat with a water intake is disclosed, the method comprising the steps of providing a water intake device having an abutment portion for defining depth of receipt in the boat hull and having a water-side face for receiving water within the water intake device, determining a size of the abutment portion, providing an opening in the boat hull for receiving the water intake, locating a shoulder within the opening at a position from an exterior surface of the boat hull, the position being based on the size of the abutment portion, positioning the water intake device within the opening with the abutment portion substantially in contact with the shoulder and the water-side face substantially flush with the exterior surface of the boat hull.

The method may include providing a plate having the water-side face. The method may include providing obliquely angled throughbores in the water-side face for permitting water passage therethrough. The method may include angling the throughbores with respect to the water-side face at an angle between 10 and 30 degrees. The method may include angling the throughbores with respect to the water-side face at an angle of substantially 20 degrees.

### BRIEF DESCRIPTION OF THE DRAWINGS

In the Figures, FIG. 1 is perspective view of a water intake device for mounting on a boat hull of the present invention, the water intake device having a screen or plate portion facing a water body supporting the boat;

FIG. 2 is a reduced, exploded perspective view of the water intake device of FIG. 1 showing a body portion for securing within the hull wall and the interior surface of the hull, and showing the screen securable with the body;

FIG. 3 is a bottom plan view of the screen of the water intake device of FIG. 1 showing an external surface thereof securable with the boat hull so as to be facing the water body supporting the boat;

FIG. 4 is a perspective view of the screen of FIG. 3 the holes being partially in phantom to show passage therethrough from the external surface of the screen to an internal surface communicating with the body portion to permit conveyance of water to the coolant system;

FIG. 5 is a side elevational view of the intake device of FIG. 1 mounted with a boat hull in cross-section via a nut, FIG. 5 also showing the body having a shape for promoting passage of water therethrough and minimizing transition from laminar to turbulent flow therein;

FIG. 6 is a side elevation view of a second form of intake device corresponding to FIG. 5 wherein the intake device has a generally concave water-side surface; and

FIG. 7 is a side elevational view of a third form of an intake device corresponding to FIGS. 5 and 6 wherein the intake device has a generally convex water-side surface.

### DETAILED DESCRIPTION

Referring to the Figures, a device for a water intake 10 of the present invention is shown having a body 12 and a plate 14 mounted thereto. The intake 10 promotes ingress of water from a body of water supporting a boat or water craft to which the intake 10 may be mounted, the water then being delivered to a raw water system or well, such as a coolant system for the engine powering the boat, for instance. It will be appreciated that while the intake 10 is discussed herein as providing a source of water for an engine coolant system, the intake 10 of the present invention may be used to provide a source of water for any system in a boat. Towards this end, the plate 14 has a number of throughbores 20 extending from a first side, referred to herein as a water side 16, to a second side, referred to herein as an internal side 18, the passages permitting water to pass from the water body into the intake 10. It should be noted that the plate 14 may be generally flat or may have a contour shaped to correspond generally to the shape of the area on a boat to which it is mounted.

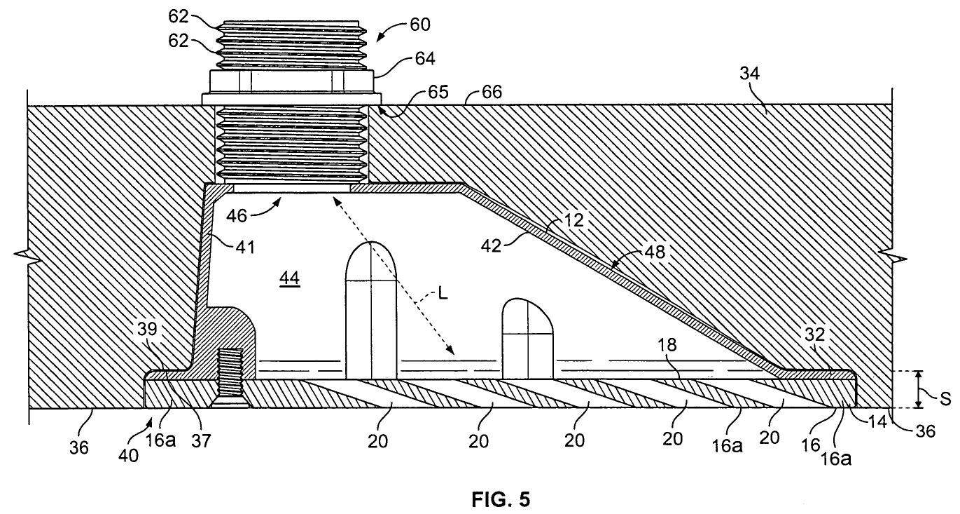

In an embodiment, the body 12 has a generally ovoid base portion 30 including a small flange 32 extending radially therefrom. When mounted in a boat hull 34, as can seen in FIG. 5, the flange 32 is recessed into the hull 34 so that the plate 14 mounted to the body 12 is preferably flush with the skin 36 or external surface of the hull 34.

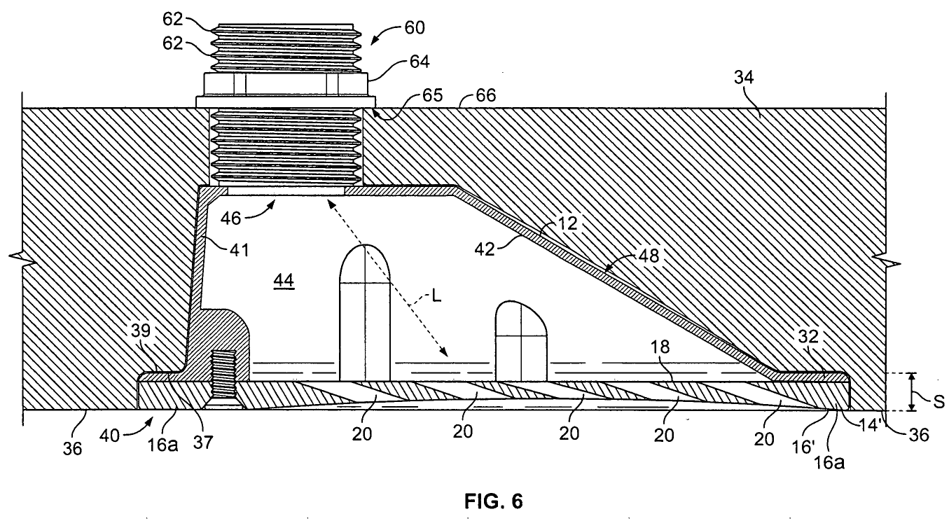

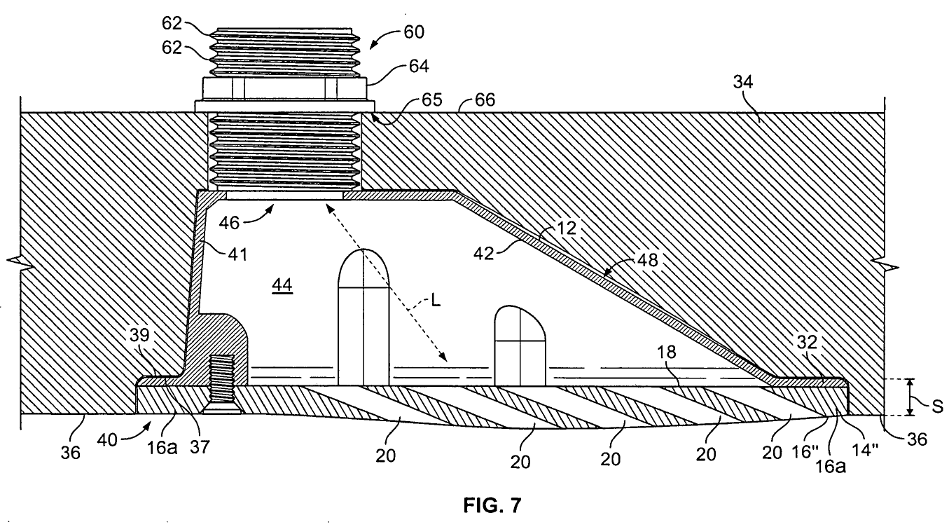

More specifically, a peripheral portion 16a of the water-side surface 16 of the flange 32 is mounted flush with the skin 36 of the hull 34. In one form, the plate 14 may have a flat water side 16, as best seen in FIG. 5. In other forms, a plate 14′ may have a concave water side 16′, as seen in FIG. 6. In still other forms, a plate 14″ may be convex on a water side 16″, shown in FIG. 7. For each, a peripheral portion 16a of the plates 14, 14′ and 14″ is mounted substantially flush with the hull skin 36.

To install, a portion of the hull 34 is cut-out leaving a shoulder 37 thereon, and the flange 32 forms an abutment portion 39 abutable against the shoulder 37 to define the receipt of the intake 10 within the cut-out. The depth of the shoulder 37 with respect to the skin 36 of the hull 34 is sized with respect to the flange 32 and the plate 14, the size being represented as S in FIG. 5. By the intake 10 being flush with the skin 36, this minimizes and eliminates drag that would normally occur if any portion of the intake 10 were to otherwise protrude from the hull 34 into the water body. It has further been demonstrated that with the present invention cavitation of the trailing water stream in the water body is substantially reduced or eliminated to the extent that a demonstrable increase in speed for the boat itself is experienced.

Within the flange 32, the body 12 defines a first body opening 40 into which water passing through the plate 14 initially is received. The body 12 preferably includes a funnel portion 42 rising and extending upwardly from the flange 32. The funnel portion 42 defines an internal passage 44 for communicating the water received therein to a second body opening 46, which in turn communicates the water to an attached pipe or hose or the like to an engine coolant system (not shown) or other water-based system. The funnel portion 42 has a generally constant wall thickness from the internal passage 44 to an outer surface 48. The funnel portion 42 is externally and internally shaped as an oblique frustum of a cone so that, when mounted on the hull 34, port and starboard halves are mirrors of each other, while fore and aft halves are not. Specifically, a center line L of the internal passage 44 is angled rearwardly from the first body opening 40 to the second body opening 46, as best seen in FIG. 5. With this construction, the intake 10 promotes the uptake of water therein by efficiently funneling the water received therein and, thereby, reducing the drag that is experienced by prior art devices having an internal passage that is generally orthogonal to the boat hull Though a trailing portion 41 (FIG. 5) is generally orthogonal to the plate water side 16, such trailing portion 41 may also be angled rearwardly so as to further promote water flow into a nipple portion 60, discussed below.

Continuing with FIG. 5, it can be seen that the second body opening 46 communicates the water to a nipple portion 60. A connection may be made between the nipple portion 60 and the engine coolant system. Additionally, the nipple portion 60 may include external threads 62 for receiving a nut 64. As the nut 64 is secured onto the threads 62, the intake 10 is drawn into the hull 34 until the plate 14 is substantially flush with the hull skin 36 and a face 65 of the nut 64 is in abutment with an inner surface 66 of the hull 34. When mounted, the face 65 opposes the abutment portion 39 of the flange 32. By mounting the intake 10 in the present manner within the hull 34, the fitting and connection between the hull 34 and the intake is improved, and the integration therebetween provides superior strength and life cycle for the connection therebetween.

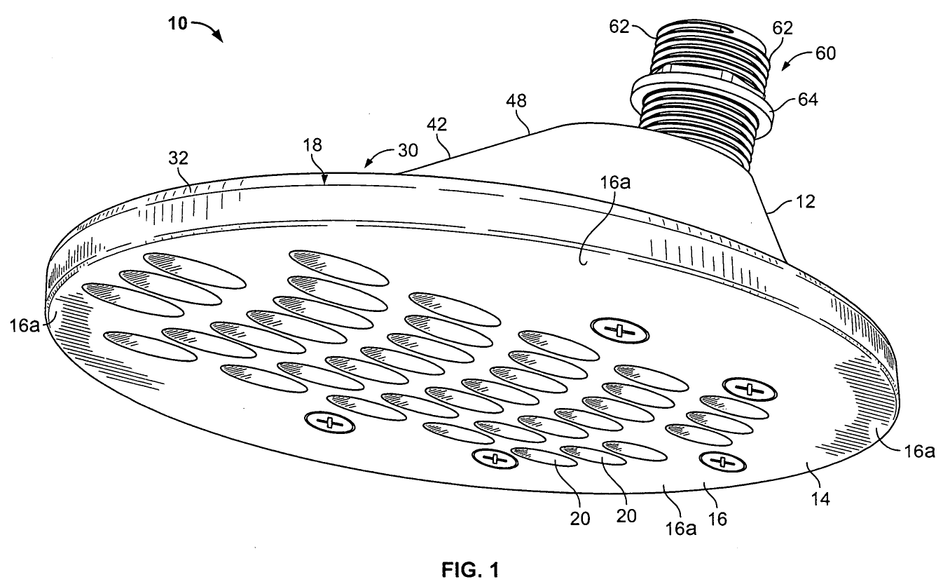

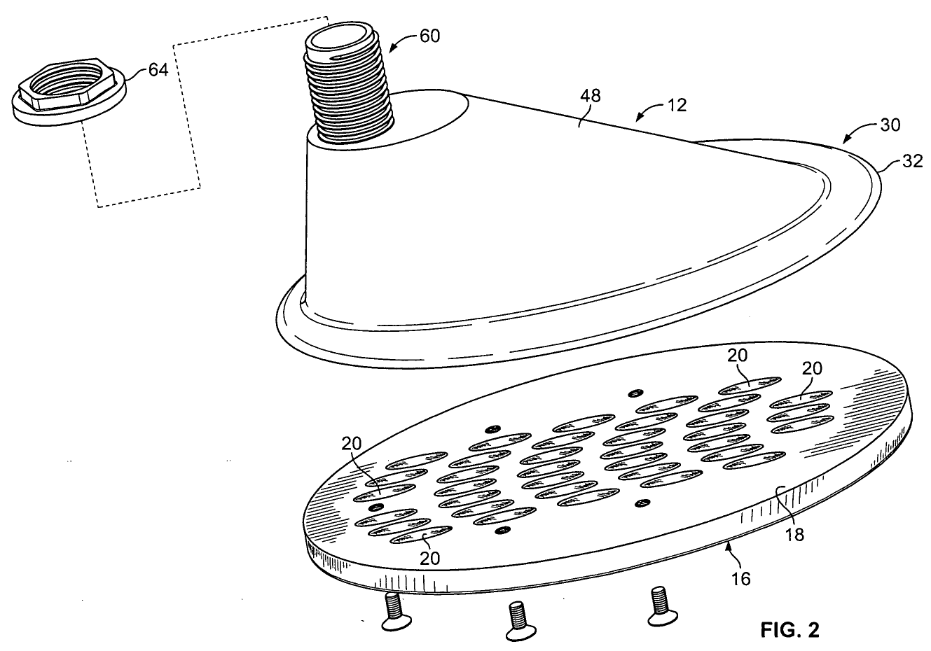

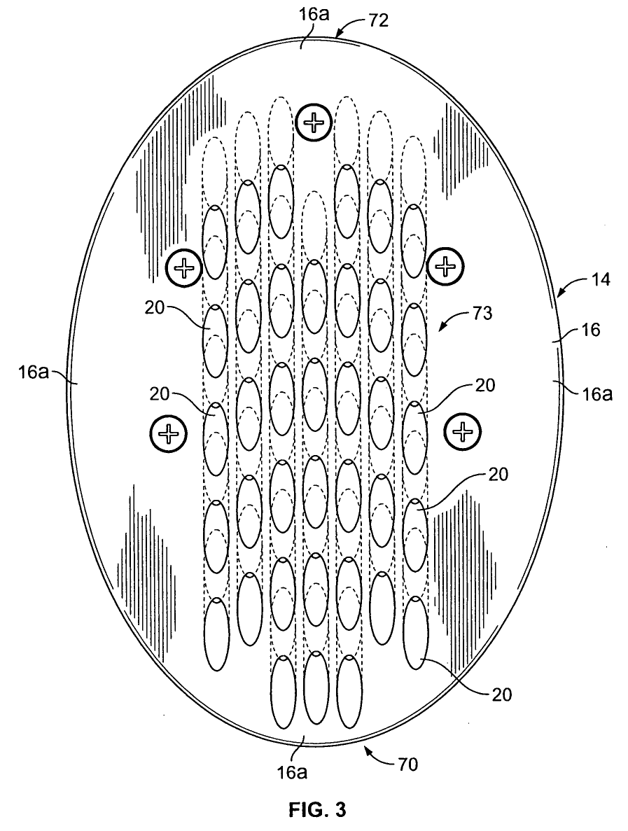

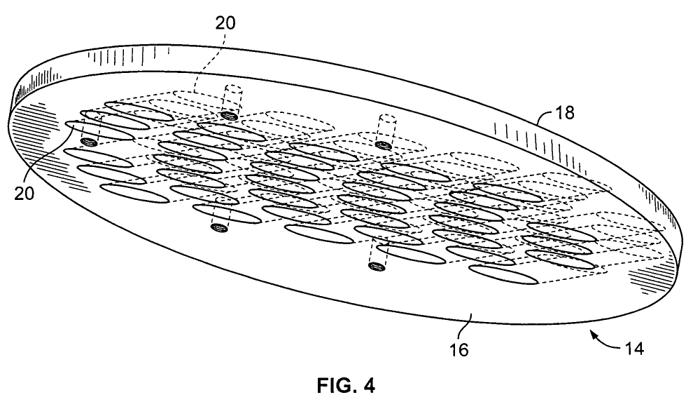

The plate 14 and the throughbores 20 are best viewed in FIGS. 2-4. The plate 14 is designed to maximum the flow of water through the throughbores 20, while also minimizing the ability of undesirable matter (such as weeds or debris) to enter the intake 10 and, thus, the raw water system (such as a coolant system) or well. As can be seen, the throughbores 20 are arrayed with several towards a fore or leading portion 70 of the plate 14 and others in arced rows 73 from the leading portion 70 towards an aft or trailing portion 72 of the plate.

Each of the throughbores 20 is preferably formed at an oblique angle from the plate sides 16, 18. When the intake 10 is mounted on a hull 34, the throughbores 20 are angled rearwardly from the plate water side 16 to the plate internal side 18, as best seen in FIG. 5. This oblique angle is preferably between 10 and 30 degrees and, more preferably, is 20 degrees, thereby improving the water uptake capabilities of the intake 10.

While previous intakes rely on forcing water into the intake, such as with a scoop, the present intake 10 advantageously utilizes Bernoulli's principle. More specifically, the fast moving water molecules across the water side 16 of the plate 14 cause a negative pressure (or, decrease in localized pressure). Accordingly, the pressure in and about the throughbores decreases, and the water is naturally sucked into the intake 10. Importantly, the faster the boat travels, which typically results in higher heat generation by the engine due to the engine output, the greater the pressure differential between the water side 16 and the internal side 18, thus causing increased water flow to adequately cool the engine.

As should be clear, the invention further encompasses a method for installing an intake. That is, the method includes providing a water intake device having an abutment portion for defining depth of receipt in the boat hull and having a water-side face for receiving water within the water intake device, determining a size of the abutment portion, providing an opening in the boat hull for receiving the water intake, locating a shoulder within the opening at a position from an exterior surface of the boat hull, the position being based on the size of the abutment portion, positioning the water intake device within the opening with the abutment portion substantially in contact with the shoulder and the water-side face substantially flush with the exterior surface of the boat hull. The method may include providing a plate having the water-side face. The method may include providing obliquely angled throughbores in the water-side face for permitting water passage therethrough. The method may include angling the throughbores with respect to the water-side face at an angle between 10 and 30 degrees. The method may include angling the throughbores with respect to the water-side face at an angle of substantially 20 degrees.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. An intake device for a boat, the intake device comprising:
a body portion securable with a hull of the boat;
an intake plate having a water-side surface and an internal-side surface, and having a plurality of throughbores extending between the water-side and internal-side surfaces, the throughbores permitting passage of water therethrough and sized to impede ingress of undesirable matter therethrough, the throughbores being obliquely angled with respect to the water-side surface of the plate, the water-side surface of the plate generally following the contour of the hull.

2. The intake device of claim 1 wherein the throughbores are obliquely angled between approximately 10 and 30 degrees from the water-side surface of the plate.

3. The intake device of claim 2 wherein the throughbores are obliquely angled at approximately 20 degrees from the water-side surface of the plate.

4. The intake device of claim 1 further including an abutment portion defining the amount of receipt of the intake within the hull, wherein a peripheral portion of the water-side surface of the plate is mounted substantially flush with an exterior surface of the hull.

5. The intake device of claim 4 further including a mounting portion for mounting the intake within hulls of varying thickness.

6. The intake device of claim 5 wherein the mounting portion includes a threadably adjustable nut having a face opposed to the abutment portion.

7. The intake device of claim 4 wherein the abutment portion is formed on the body.

8. The intake device of claim 1 wherein the body includes an interior passage in fluid communication with the plate throughbores for communicating water received therein to a raw water system, the interior passage being contoured to funnel the water to the raw water system.

9. In combination with a boat hull having a thickness, an interior surface, and an exterior surface, a water intake device for delivering raw water to a portion of the boat, the intake device comprising:
a body portion securable with the hull of the boat;
an intake plate having a water-side surface and an internal-side surface, and having a plurality of throughbores extending between the water-side and internal-side surfaces, the throughbores permitting passage of water therethrough and sized to impede ingress of undesirable matter therethrough, the throughbores being obliquely angled with respect to the water-side surface of the plate,
wherein the water-side surface of the plate generally follows the contour of the hull, and the plate is secured with a peripherally portion thereof substantially flush with the exterior surface of the boat hull.

10. (canceled)

11. The combination of claim 9 wherein the throughbores are obliquely angled between approximately 10 and 30 degrees from the water-side surface of the plate.

12. The combination of claim 11 wherein the throughbores are obliquely angled at approximately 20 degrees from the water-side surface of the plate.

13. The combination of claim 9 wherein the intake device further includes an abutment portion defining the amount of receipt of the intake within the hull.

14. The combination of claim 13 further including a mounting portion for mounting the intake within hulls of varying thickness.

15. The combination of claim 14 wherein the mounting portion includes a threadably adjustable nut having a face opposed to the abutment portion.

16. The combination of claim 13 wherein the abutment portion is formed on the body.

17. The combination of claim 9 wherein the body includes an interior passage in fluid communication with the plate throughbores for communicating water received therein to a raw water system, the interior passage being contoured to funnel the water to the raw water system.

18. A method of providing a boat with a supply of water for a water system, the method comprising the steps of:
providing a water intake device having an abutment portion for defining depth of receipt in the boat hull and having a water-side face for receiving water within the water intake device;
determining a size of the abutment portion;
providing an opening in the boat hull for receiving the water intake;
locating a shoulder within the opening at a position from an exterior surface of the boat hull, the position being based on the size of the abutment portion;
positioning the water intake device within the opening with the abutment portion substantially in contact with the shoulder and the water-side face having a peripheral portion substantially flush with the exterior surface of the boat hull.

19. The method of claim 18 further including providing a plate having the water-side face.

20. The method of claim 18 further including providing obliquely angled throughbores in the water-side face for permitting water passage therethrough.

21. The method of claim 20 further including angling the throughbores with respect to the water-side face at an angle between approximately 10 and 30 degrees.

22. The method of claim 20 further including angling the throughbores with respect to the water-side face at an angle of substantially 20 degrees.
